(19) United States
(12) Patent Application Publication
(10) Pub. No.: US 2025/0102139 A1
(43) Pub. Date: Mar. 27, 2025

(54) LIGHTING MODULE, PRODUCTS AND SYSTEM

(71) Applicant: Black & Decker Inc., New Britain, CT (US)

(72) Inventors: Daniel L. Schwarz, Jarrettsville, MD (US); Kristian B. Sims, Baltimore, MD (US); Daniel K. Hardy, York, PA (US); Matthew Lazzaro, Forest Hill, MD (US); Thomas E. Streett, Fallston, MD (US); Steven J. Phillips, Ellicott City, MD (US)

(73) Assignee: Black & Decker Inc., New Britain, CT (US)

(21) Appl. No.: 18/908,992

(22) Filed: Oct. 8, 2024

Related U.S. Application Data
(63) Continuation of application No. PCT/US24/48337, filed on Sep. 25, 2024.
(60) Provisional application No. 63/540,412, filed on Sep. 26, 2023.

(51) Int. Cl. F21V 33/00; B23Q 17/24; F21V 23/00; F21Y 115/10

(52) U.S. Cl. CPC F21V 33/0084; B23Q 17/2404; F21V 23/005; F21Y 2115/10

(57) ABSTRACT

A power tool light product includes a light body including a power tool battery pack receptacle, the power tool battery pack receptacle configured to removably receive a power tool battery pack that is configured to selectively power the power tool light product and at least one of a drill, a saw, a sander, or a concrete tool. The power tool light product also includes a lighting module, the lighting module operably coupled to the power tool battery pack receptacle. The lighting module includes a printed circuit board, an LED on the printed circuit board, and an LED driver on the printed circuit board.

### CROSS-REFERENCE TO RELATED APPLICATIONS

This application is a continuation of and claims priority to International PCT Application No. PCT/US2024/48337 filed Sep. 25, 2024, which claims priority to U.S. Provisional Patent Application No. 63/540,412 filed Sep. 26, 2023, all of which are incorporated herein by reference in their entirety.

### BACKGROUND

The present disclosure relates to lighting modules, lighting products including a lighting module and power tool lighting product systems.

### SUMMARY

Aspects of the present disclosure relate to example embodiments of a lighting module, lighting products including a lighting module and power tool lighting product system.

According to an aspect, an example embodiment of a power tool light product, includes: a light body comprising a power tool battery pack receptacle, the power tool battery pack receptacle configured to removably receive a power tool battery pack that is configured to selectively power the power tool light product and at least one of a drill, a saw, a sander, or a concrete tool; a lighting module, the lighting module operably coupled to the power tool battery pack receptacle. The lighting module comprises: a printed circuit board; an LED on the printed circuit board; and a controller on the printed circuit board.

The power tool light product may further include an LED driver on the printed circuit board.

The LED driver may be a constant current LED driver.

The power tool light product may further include an integrated circuit regulator configured to provide a constant output voltage.

The printed circuit board may further include an insulated metal substrate.

The power tool light product may further include a connector.

The connector may be disposed near an edge of the printed circuit board.

The connector may be configured to facilitate connection of the controller to the power tool battery pack receptacle.

According to another aspect of an example embodiment, a power tool light product includes a light body comprising a power tool battery pack receptacle, the power tool battery pack receptacle configured to removably receive a power tool battery pack that is configured to selectively power the power tool light product and at least one of a drill, a saw, or a sander. The power tool light product further includes a lighting module, the lighting module operably coupled to the power tool battery pack receptacle. The lighting module includes a printed circuit board; a plurality of LEDs on the printed circuit board; a controller on the printed circuit board; and an LED driver on the printed circuit board.

The plurality of LEDs may be arranged in an array.

The array may be an n×n array in which n is a positive integer.

The array may be an m×n array in which m and n are positive integers and m is a different integer than n.

The printed circuit board may have a front face with a central region and an outer region.

The plurality of LEDs may be in the central region.

The controller and the LED driver may be in the outer region.

The printed circuit board may include an insulated metal substrate.

The power tool light may further include a resistor on the printed circuit board.

The power tool light may further include a plurality of resistors on the printed circuit board.

The power tool light may further include a capacitor on the printed circuit board.

The power tool light may further include a plurality of capacitors on the printed circuit board.

The power tool light may further include an inductor on the printed circuit board.

The power tool light may further include a plurality of inductors on the printed circuit board.

According to an aspect of an example embodiment, a power tool light product includes: a light body comprising a power tool battery pack receptacle, the power tool battery pack receptacle configured to removably receive a power tool battery pack that is configured to selectively power the power tool light product and at least one of a drill, a saw, or a sander. The power tool light product also includes a lighting module assembly, the lighting module assembly comprising a lighting module, a heat sink and a lighting module housing. The lighting module comprises a printed circuit board having a front surface and a rear surface; an LED on the front surface of the printed circuit board; a controller on the front surface of the printed circuit board; and an LED driver on the front surface of the printed circuit board. The heat sink extends from the rear surface of the printed circuit board.

The lighting module housing includes a reflector.

The power tool light product may further include a gasket between the printed circuit board and the reflector.

The printed circuit board may include a central region and an outer region.

The LED may be in the central region.

The gasket may be around the central region of the printed circuit board.

The controller may be in the outer region of the printed circuit board.

The power tool light product may further include a first gasket and a second gasket. The printed circuit board may include a central region and an outer region. The LED may be in the central region. The controller may be in the outer region. The first gasket may be around the central region. The second gasket may be around the outer region.

The heat sink may include a plurality of heat dissipating projections extending in a direction transverse to the rear surface of the printed circuit board.

The plurality of heat dissipating projections may be disposed in an array.

According to an aspect of an example embodiment, a light, includes: a base configured to sit on a surface; a support remote from the base; a first arm extending between the base and the support; a lighting module attached to the support, the lighting module comprising at least one light generator; and a battery pack receptacle between the base and the support, the battery pack receptacle configured to receive a removable power tool battery pack.

The light may further include a second arm extending between the base and the support; and a third arm extending between the base and the support.

The battery pack receptacle may be disposed such that the removable power tool battery pack received in the battery pack receptacle is in a space between the first arm, the second arm and the third arm.

The base may have a circular shape.

The support may have a circular shape.

The light may further include a light cover over at least a portion of the light generator.

The light cover may be attached to the support.

The light generator may include an LED.

The light module may include a printed circuit board, a controller on the printed circuit board, and an LED driver on the printed circuit board.

The LED may be on the printed circuit board.

The printed circuit board may further include a connector configured to facilitate connection of the controller to the battery pack receptacle.

According to an aspect of an example embodiment, a power tool light system, includes: a first light product, the first light product comprising a first light body and a first power tool battery pack receptacle configured to removably receive a power tool battery pack; wherein the first light product comprises a first lighting module, the first lighting module comprising a first printed circuit board, a first LED on the first printed circuit board, a first controller on the first printed circuit board, and a first LED driver on the first printed circuit board; a second light product, the second light product comprising a second light body and a second power tool battery pack receptacle configured to removably receive a power tool battery pack; wherein the second light product comprises a second lighting module, the second lighting module comprising a second printed circuit board, a second LED on the printed circuit board, a second controller on the printed circuit board, and a second LED driver on the second printed circuit board; wherein the first light body has a different configuration than the second light body.

The first light product may be an area light.

The second light product may be a flashlight or a tripod light.

The first LED driver may be substantially the same as the second LED driver.

The first controller hardware may be substantially the same as the second controller hardware.

The first printed circuit board may have a first printed circuit board central region and a first printed circuit board outer region.

The first LED may be in the first printed circuit board central region.

The first controller and the first LED driver may be in the first printed circuit board outer region.

The second printed circuit board may have a second printed circuit board central region and a second printed circuit board outer region. The second LED may be in the second printed circuit board central region. The second controller and the second LED driver may be in the second printed circuit board outer region.

According to an aspect of an example embodiment, a power tool light system, includes: a first light product, the first light product comprising a first light body and a first power tool battery pack receptacle configured to removably receive a power tool battery pack; wherein the first light product comprises a first lighting module, the first lighting module comprising a first printed circuit board, a first LED on the first printed circuit board, a first controller on the first printed circuit board, and a first LED driver on the first printed circuit board; a second light product, the second light product comprising a second light body; wherein the second light product comprises a second lighting module, the second lighting module comprising a second printed circuit board, a second LED on the printed circuit board, a second controller on the printed circuit board, and a second LED driver on the second printed circuit board; wherein the first light body has a different configuration than the second light body.

The first printed circuit board may have the same shape as the second printed circuit board.

The first printed circuit board may have the same size as the second printed circuit board.

The system may further include a first connector on the first printed circuit board and a second connector on the second printed circuit board and wherein the first connector has the same relative location on the first printed circuit board as the second connector has on the second printed circuit board.

The system may further include a first resistor on the first printed circuit board and a second resistor on the second printed circuit board and wherein the first resistor has the same relative location on the first printed circuit board as the second resistor has on the second printed circuit board.

The system may further include a first capacitor on the first printed circuit board and a second capacitor on the second printed circuit board and wherein the first capacitor has the same relative location on the first printed circuit board as the second capacitor has on the second printed circuit board.

The system may further include a first array of LEDs on the first printed circuit board and a second array of LEDs on the second printed circuit board and wherein the first array of LEDs has the same number of LEDs, rows and columns as the second array of LEDs.

The second light product may be configured to be engaged with and powered by a second power tool battery pack. The second power tool battery pack may be such that it is not configured to be engaged with the first light product to power the first light product. The first power tool battery pack may be such that it is not configured to be engaged with the second light product to power the second light product. The second power tool battery pack may have a different voltage (maximum initial battery voltage measured without a workload) than the first power tool battery pack. The second power tool battery pack may have a voltage that is at least 50% higher than a voltage of the first power tool battery pack. The second power tool battery pack may have a voltage that is at least 100% higher than a voltage of the first power tool battery pack.

These and other aspects of various embodiments, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

Example embodiments of the present application are described with reference to and in conjunction with the accompanying drawings, in which:

FIG. 1 is a perspective side view of a lighting product according to an exemplary embodiment;

FIG. 2 is a perspective view of part of the lighting product according to an exemplary embodiment;

FIG. 3 is a perspective view of a lighting module according to an exemplary embodiment;

FIG. 4 is an exploded view of a lighting module according to an exemplary embodiment;

FIG. 5 is a perspective view of a lighting module according to an exemplary embodiment;

FIG. 6 is a cross-sectional view of a lighting module according to an exemplary embodiment;

FIG. 7 is a perspective cross-sectional view of a lighting module according to an exemplary embodiment;

FIG. 8 is a schematic of an electrical configuration of a lighting product according to an exemplary embodiment;

FIG. 9 is a schematic of a lighting product with a common core according to an exemplary embodiment;

FIG. 10 is a schematic of a lighting product with a common core according to an exemplary embodiment;

FIG. 11 is a schematic of a lighting product with a common core according to an exemplary embodiment;

FIG. 12 is a schematic of a lighting product with a common core according to an exemplary embodiment;

FIG. 13 is a cross-sectional side view of a flashlight product according to an exemplary embodiment;

FIG. 14 is a cross-sectional perspective view of a flashlight product according to an exemplary embodiment;

FIG. 15 is a perspective view of a task light product according to an exemplary embodiment;

FIG. 16 is a perspective view of a task light product according to an exemplary embodiment.

FIG. 17 is a perspective view of a tripod light product according to an exemplary embodiment.

### DETAILED DESCRIPTION OF EXEMPLARY EMBODIMENTS

The drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

As used herein, the terminology “at least one of A, B and C” and “at least one of A, B and C” each mean any one of A, B or C or any combination of A, B and C. For example, at least one of A, B and C may include only A, only B, only C, A and B, A and C, B and C, or A, B and C.

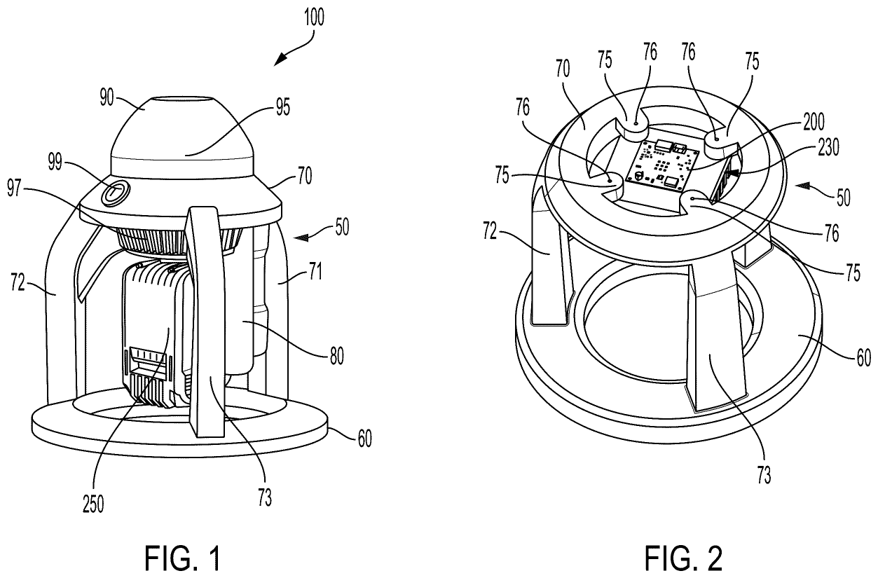

FIGS. 1 and 2 illustrate an example embodiment of a power tool lighting product 100. The power tool lighting product 100 of the example embodiment is an area light, in particular, a basket area light. As shown, the basket light 100 includes a cage housing 50. The cage housing 50 includes a base 60 and three arms 71, 72, 73. The base 60 may have a generally flat and horizontal base at its bottom such that if the base 60 is placed on a flat horizontal surface such as a table or floor, the base 60 sits roughly flat and the arms 71, 72, 73 extend generally vertically from the base 60. The base 60 may also be placed on uneven or angled surfaces. The cage housing 50 further includes a support 70. The arms 71, 72, 73 extend from the base 60 to the support 70.

A battery receptacle 80 is in a space defined by the arms 71, 72, 73 and receives a battery pack 250. The battery pack 250 may be a rechargeable and removable battery pack. In an embodiment, the battery pack 250 may be a power tool battery pack. The battery pack 250 may be configured to power various power tools in a power tool system. For example, the power tool battery pack 250 may be engaged with the battery receptacle 80 to power the light 100. The power tool battery pack 250 may also be removed from the receptacle 80 of the light 100 and engaged with another tool, such as a drill, a saw, a sander, or an impact driver, and power the tool with which it is engaged. In other embodiments, the light 100 may include an integral power source, such as an integral battery. In other embodiments, the light 100 may include a power cord or socket to allow for AC power from a standard outlet. In some embodiments, multiple power sources may be used together or alternatively. For example, in an embodiment, the light 100 may alternatively be powered by a battery pack 250 or be plugged into an AC outlet.

The power tool battery pack 250 may have a nominal voltage of approximately 18 volts (V) and a maximum initial battery voltage (measured without a workload) of approximately 20 V. In some embodiments, the battery pack receptacle 80 may be configured to receive a variety of different battery packs and the light 100 may be configured to operate with power from the variety of different battery packs. For example, in an embodiment, the battery pack receptacle 80 may be configured to receive a variety of battery packs having a nominal voltage of approximately 18 volts (V) and a maximum initial battery voltage of approximately 20 V, with the battery packs varying in capacity. For example, a first battery pack may have a capacity of approximately 3 amp-hours, a second battery pack may have a capacity of approximately 5 amp-hours and a third battery pack may have a capacity of approximately 10 amp-hours. Additionally or alternatively, the battery pack receptacle 80 may be configured to receive and the light 100 may be configured to operate with battery packs of different voltages. For example, the light 100 may additionally or alternatively be configured to operate with battery packs having a nominal voltage of approximately 10.8 volts (V) and a maximum initial battery voltage of approximately 12 V, or battery packs having a nominal voltage of approximately 54 volts (V) and a maximum initial battery voltage of approximately 60 V.

As shown in FIG. 2, four attachment projections 75 extend from the support 70. The attachment projections 75 include screw holes 76. A lighting module assembly 78 is held below the attachment projections 75 and attached to the attachment projections 75. Fasteners, such as screws, may extend between the attachment projections 75 and the lighting module assembly 78 to fix the lighting module assembly 78. A lighting module 200 is at a center of the lighting module assembly 78. The lighting module assembly 78 also includes a heat sink 320 extending downwardly. The heat sink 320 may include heat dissipating projections, for example, a plurality of generally parallel, longitudinally extending heat dissipating fins.

As shown in FIG. 1, a cover 97 covers the heat sink 320. The cover 97 may include a metal, a plastic or another material. The cover 97 may include fins projecting outwardly.

As shown in FIG. 1, the light 100 may further include light covers 95 and 90. In the example embodiment, there are two light cover 90 and 95. In other embodiments, there may be only one of the light covers 90, 95 or there may be more than two light covers. As shown, the light cover 95 is relatively near to the lighting module 200. Light cover 95 provides a first diffusion of light. Second light cover 90 is outside of the first light cover 95. Second light cover 95 provides a second diffusion of light from the light module 200. As shown in FIG. 1, there may be a user interface 99. The user interface 99 may include one or more buttons, such as for turning the light on and off or adjusting an intensity of the light. The light 100 may be further operated wirelessly. The wireless controls may be instead of or in addition to the controls of the user interface 99. In some embodiments, there may be some functions which can be controlled wirelessly or some functions that can only be controlled with an on-board user interface 99. A wireless transceiver may be on the PCB 210 described below and communicate with controller 230.

In the light 100, the lighting module 200 is stationary with respect to the cage housing 50 and the base 60.

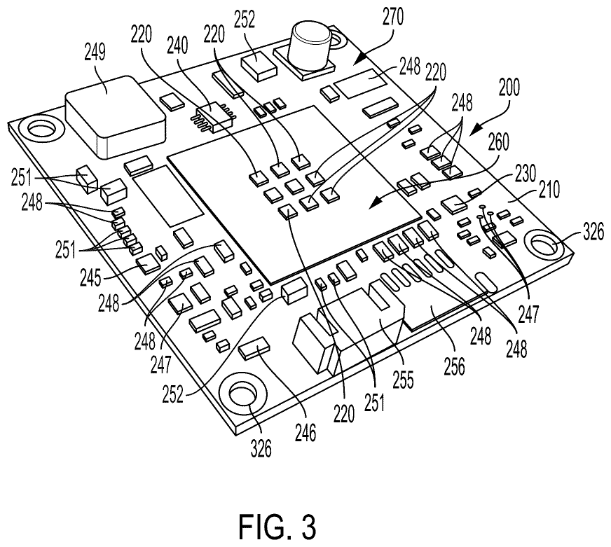

FIG. 3 illustrates an exemplary embodiment of a lighting module 200. The lighting module 200 of the exemplary embodiment includes an all-in-one light emitting diode (LED) module that combines LEDs and LED driving circuitry on a single printed circuit board (PCB). The PCB 210 may be an insulated metal substrate (IMS). The IMS may provide beneficial heat transfer and may be relatively small.

As shown in FIG. 3, a plurality of LEDs 220 may be on a front surface of the PCB 210. In the example embodiment, there is an array of nine LEDs 220. The nine LEDs 220 are arranged in a 3×3 array. In other example embodiments, there may be at least 3 LEDs; at least 5 LEDs; or at least 7 LEDs. The array may also be changed. For example, embodiments may include other even arrays in which the number of LEDs in each row and column is equal. That is, the array may be an n×n array as a 4×4, 5×5 or 6×6 array. In other embodiments, the number of LEDs in the column and rows of the array may be different (e.g., an m×n array, where n and m are different integers). For example, there may be a 3×5 array; a 3×6 array; a 4×5 array or a 4×6 array. The integer n may be at least 3, at least 4, at least 5, or at least 6. The integer n may be less than 12; less than 10 or less than 8. The integer m may be at least 2; at least 3, at least 4, at least 5, at least 6 or at least 7. The integer m may be less than 20; less than 18; less than 16; or less than 14. For example, in an example embodiment, the integer n may be at least 2 and less than 12; and the integer m may be at least 3 and less than 20.

The lighting module 200 includes a controller 230 on the PCB 210. The controller 230 may include a microprocessor. The lighting module 200 also includes an LED driver 240. The LED driver 240 may be a constant current LED driver.

The controller 230 is configured to control the hardware of the light. The controller 230 is configured to control the operation of the LEDs 220. For example, the controller 230 is configured to turn the LEDs 220 off and on and control a brightness of the LEDs 220. The controller 230 is configured to respond to user inputs. For example, the user interface 99 may include a + button for increasing a brightness of the LEDs 220 and a − button for decreasing a brightness of the LEDs 220. The controller 230 may receive a signal from the user interface 99 and control a brightness of the LEDs 220 in response to the received signal from the user interface 99. The controller 230 may control a brightness of the LEDs 220 through the LED driver 240.

The lighting module 200 may further include an integrated circuit regulator 245 configured to provide a constant output voltage. The integrated circuit regulator 245 may regulate power from the battery pack 250.

A connector 255 is disposed near an edge of the printed circuit board 200. The connector 255 may receive a wire harness with the other end operably connected to the power tool battery pack receptacle 80. The connector 255 may include four connector pins. In some embodiments, the connector 255 may include at least two connector pins, at least four connector pins, or at least six connector pins. In some embodiments, the connector 255 may include twelve or fewer connector pins. Accordingly, the PCB 210 and the components on the PCB 210 may be electrically connected to the power source in the form of battery pack 250. There may be a second connector 256 for facilitating additional connections between the PCB 210 and other components. The second connector 256 may include six connector pins. In some embodiments, the second connector 256 may include at least two connector pins, at least four connector pins, or at least six connector pins. In some embodiments, the second connector 256 may include twelve or fewer connector pins.

The lighting module 200 may include a variety of other electrical components, such as a fuse board 246, a plurality of MOSFETs 247, a plurality of resistors 248, a plurality of inductors 249, a plurality of capacitors 251, one or more Schottky diode 252, and one or more Zener diode 253.

A front face of the PCB 210 of the lighting module 200 is shown in FIG. 3 with the LEDs 220 on the front face to project light from the front face. As shown in FIG. 3, the front face has a central area 260. The LEDs 220 are arranged in the central area 260. The various other electrical components of the example embodiment are in an outer region 270. For example, the controller 230, LED driver 240, the integrated circuit regulator 245, the fuse board 246, the plurality of MOSFETs 247, the plurality of resistors 248, the plurality of inductors 249 and the plurality of capacitors 251 are in the outer region 270.

As shown in the example embodiment, the central area or region 260 may be a rectangular shape, for example a square shape. In the example embodiment, the central area 260 may include only LED components and wiring from the LED components to other components outside of the central area 260. For example, the central area 260 may be free from one or more of the controller 230, the LED driver 240, the integrated circuit regulator 245, the fuse board 246, MOSFETS 247, resistors 248, inductors 249, capacitors 251, Schottky diodes 252, or Zener diodes 253.

A coating may be applied over the LEDs 220 and encompass the central area 260. A distance from the LEDs 220 to an outer region 270 may be at least 10 millimeters (mm); at least 20 mm, at least 30 mm or at least 40 mm.

In some embodiments, the controller 230 may be at a location other than on the lighting module 200. For example, the controller 230 may be on a separate PCB and connected to the lighting module 200 including PCB 210.

Some components may be grouped. For example, there may be one more groups of three or more resistors 248 or three or more capacitors 251. The resistance of individual resistors 248 may differ from one another. The capacitance of individual capacitors 251 may differ from one another.

The module 200 may include battery detection and management circuitry and programming as part of the controller 230. In an example embodiment, the controller 230 can control the LED driver 240 output based on the sensed capability of the power source such as battery pack 250. That is, the controller 230 can control the LED driver 240 according to a first profile if the battery pack 250 has a first voltage or capacity and a second different profile if the battery pack 250 has a second voltage or capacity. For example, if the battery pack 250 has a capacity of 8 amp-hours (Ah) the LED driver 240 may be controlled by the controller 230 to provide a higher current to the LEDs 220 than if the battery pack 250 has a capacity of 4 amp-hours (Ah). In that manner, the LED driver 240 may be controlled by the controller 230 to maximize the useful output.

The controller 230 may also include other battery detection and management circuitry and programming. The controller may warn the user that a battery voltage of the battery pack 250 is below a threshold. For example, if a battery pack 250 is a relatively low voltage battery pack 250 it may be unsuitable for a high voltage light application. In other instances, a voltage of a battery pack 250 may decline as the battery pack 250 is discharged. The controller 230 may warn the user of a battery voltage below a threshold such as by the flashing of an indicator or a warning sent by wireless communication methods.

In addition to or as an alternative to a low threshold warning for the battery pack voltage, the controller may also turn off the light when the battery pack voltage drops below a threshold. In an example embodiment there may be a first threshold at which the controller 230 is configured to warn a user of a battery low voltage and a second threshold at which the controller 230 turns off the light. In the example embodiment, the second threshold may be lower than the first threshold.

The battery detection and management features included on the module 200 may also include temperature control. For example, the battery pack 250 may include a thermistor. The thermistor may detect a temperature of the battery pack 250. The controller 230 may turn off or reduce the output of the light module 200 if the sensed temperature is above a threshold.

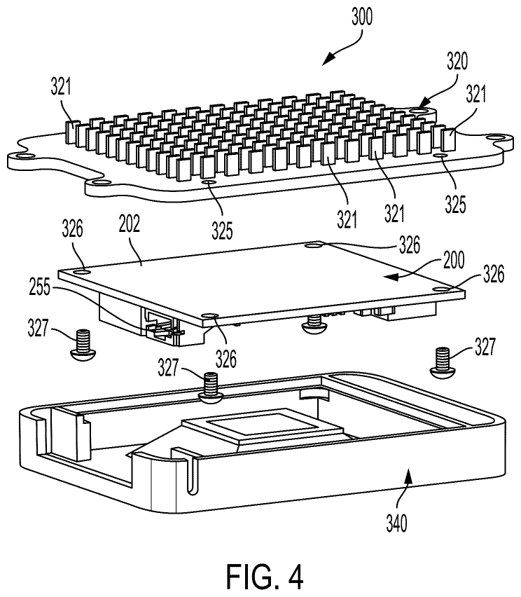

FIGS. 4-7 illustrate an example embodiment of a lighting module assembly 300 including the lighting module 200. FIG. 4 is an exploded view of the lighting module assembly 300. As shown in FIG. 4, the lighting module assembly 300 includes the lighting module 200. In FIG. 4, the rear face 202 of the PCB 210 is shown. A heat sink 320 may be connected at the rear face of the POCB 210. As shown, the heat sink 320 includes a plurality of heat dissipating projections 321. The heat dissipating projections 321 may include a material of high thermal conductivity. The heat dissipating projections 321 may include metal. The heat dissipating projections 231 may be arranged in an n×n array or an m×n array. The integer n may be at least 6, at least 8, at least 10, at least 12 or at least 15. The integer n may be 30 or less; 28 or less; 26 or less; 24 or less or 20 or less. The integer m may be at least 6, at least 8, at least 10, at least 12 or at least 15. The integer m may be 30 or less; 28 or less; 26 or less; 24 or less or 20 or less.

In the example embodiment, the heat sink 320 may include screw holes 325 and the PCB 200 may include corresponding screw holes 326. Screws 327 may engage with the screw holes 325 and 326 and secure the lighting module 200 to the heat sink 320. In other embodiments, the heat sink 320 may be secured to the lighting module 200 in other ways. For example, the heat sink 320 may be fixed to the lighting module 200 by an adhesive between the heat sink 320 and the rear face 202 of the PCB 210.

As further shown in FIG. 4, a housing 340 may be secured over a front face of the lighting module 200. The housing 340 may include plastic.

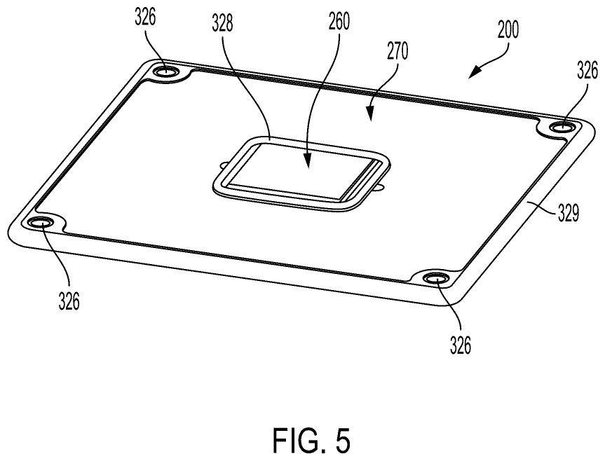

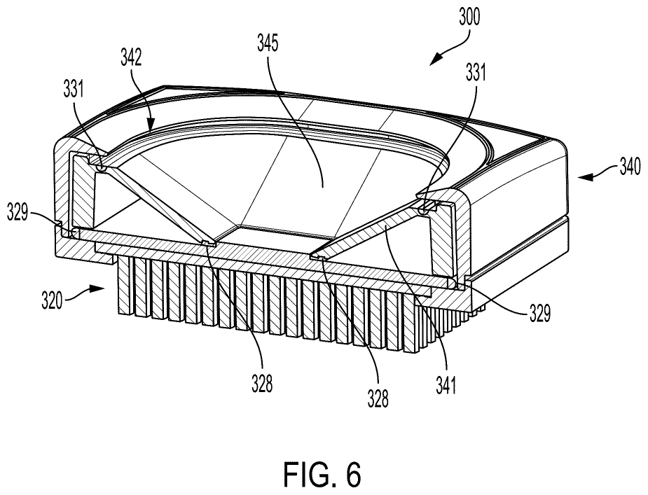

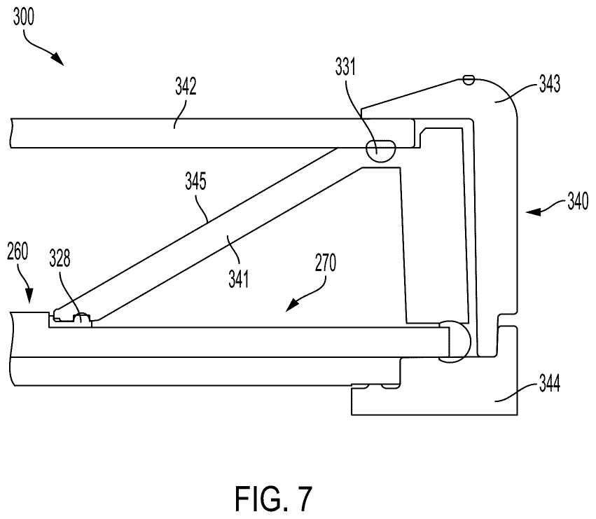

FIG. 5 illustrates a simplified view of the lighting module 200 in which the various electronic components mounted on the PCB 210 are not shown for the sake of explanation. As shown, the lighting module 200 may further include a first gasket 328 around the central portion 260 of the PCB 210 and a second gasket 329 around the outer region 270 of the PCB 210. The gaskets 328 and 329 may include silicon. As discussed in further detail with respect to FIGS. 6 and 7, the gaskets 328 may prevent moisture and dust ingress and may help to keep heat away from electrical circuitry.

FIGS. 6 and 7 are cross-sectional views illustrating the lighting module assembly 300 assembled with gaskets for preventing moisture and dust ingress. For ease of illustration, the heat dissipating projections 321 are not illustrated in FIG. 7.

As shown in FIGS. 6 and 7, the housing 340 may include several components. In particular, the housing 340 may include a reflector 341. The reflector 341 includes a reflective surface 345 which reflects light produced by the LEDs 220. The housing includes a lens 342. The lens 342 covers the reflective surface 345 of the reflector as well as the central region 260 of the PCB 210 on which the LEDs 220 are mounted. The housing 340 also includes a front retaining part 343 and a rear retaining part 344. The front and rear retaining parts 343 and 344 help to secure the assembly 300 together. The front and rear retaining parts 343 and 344 may be secured together by, for example, fasteners or an adhesive.

As shown in FIGS. 6 and 7, the gasket 328 is disposed between the PCB 210 and the reflector 341 and provides a seal between the two parts. Gasket 329 of the PCB 210 contacts the reflector 341 and rear retaining part 344. In other embodiments, the gasket 329 may also contact and provide a seal with the front retaining part 343. The assembly 300 may also include a third gasket 331 between the reflector 341 and the front retaining part 343.

The lighting module assembly 300 and components thereof such as the lighting module 200 or a similar lighting module assembly or components thereof such as the lighting module 200 may be used in a variety of different lights. For example, the same or a similar lighting module assembly 300 may be used in an area light, a flashlight, a task light. The area light, flashlight and task light may all utilize the same lighting module 200 and have different configurations for the light body for the particular function.

In an embodiment, an area light with a first light body configuration and a flashlight with a second light body configuration may both use the same lighting module 200 or a similar lighting module to one another.

The similar lighting modules may have one or more common components or layouts. For example, the lighting module of one or more different lighting products may each includes one or more of the same controller hardware, the same LED driver, one or more of the same connectors; one or more of the same resistors; one or more of the same LED arrays; the same printed circuit board size and shape; or the substantially the same layout. For example, a first area light may include a lighting module with a PCB having central region having an LED array and an outer region having a controller and an LED driver. A second area light product with a different configuration (e.g., a different area light main body; configured to receive a different type of battery pack) may also include a lighting module with a PCB having central region having an LED array and an outer region having a controller and an LED driver. The LED driver of the first area light and the second area light may be the same. The controller hardware of the first area light and the second area light may be the same. The controller of the first area light might be configured to provide at least some different operation than the controller of the second area light. For example, the second area light may incorporate a motion sensor for turning on the second area light when motion is detected and the controller of the second area light, while having the same hardware as the controller of the first area light, may be configured to operate the second area light with the motion sensor detection while the first area light may lack such a feature. Providing the same or a similar lighting module 200 or lighting module assembly 300 for more than one light product may provide efficient design.

The lighting module 200 or lighting module assembly 300 may be used in more than one product, where the electronic hardware and controller firmware are substantially the same. The controller firmware may include an algorithm whereby various configuration parameters of the lighting module 200 are selected.

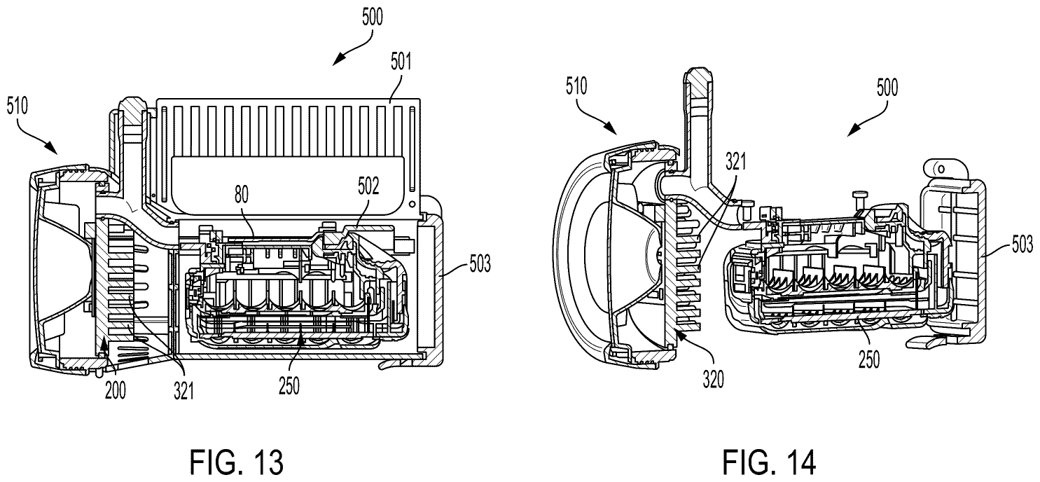

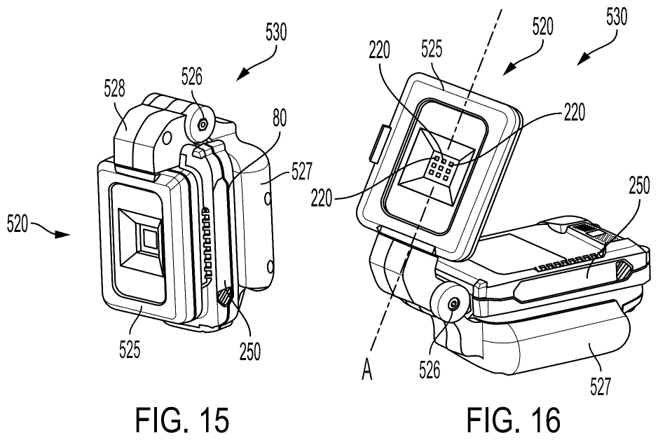

In various example embodiments, the features of the housing 340 and the heat sink 320 may be varied according to the application. For example, the size and shape of the reflector 341, the reflector surface 345 and the housing 340 may be made to be round to create a round front end for a flashlight, such as flashlight 500 of FIGS. 13 and 14. In other example embodiments, the reflector 341, the reflector surface 345 and the housing 340 may be made rectangular and may be made relatively small as in, for example, the folding task light 530 of FIGS. 15 and 16.

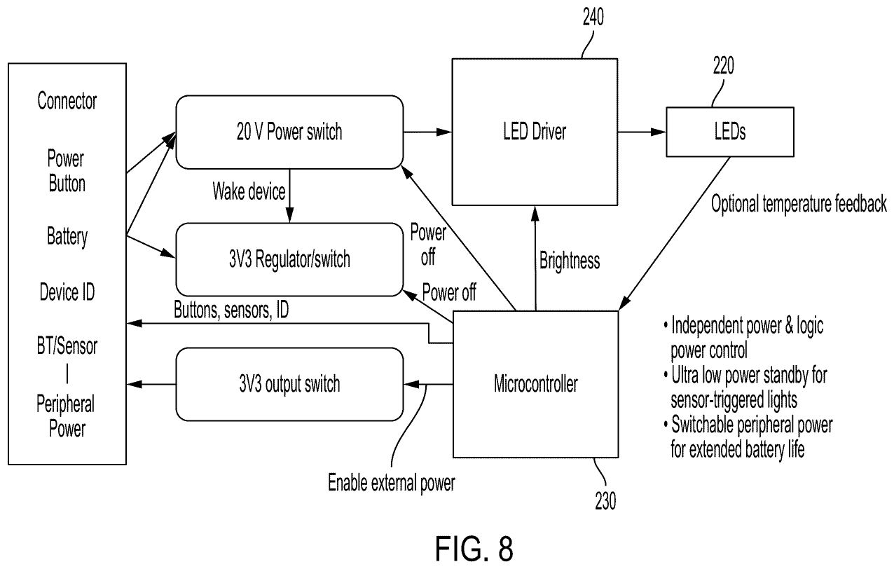

FIG. 8 is an explanatory electrical design illustration. As shown in FIG. 8, the controller 230 is operably connected to the LED driver 240 so that it can control operational brightness of the LEDs 220s. Controller 230 is further connected to various other components to control other functions. For example, the controller 230 may receive temperature feedback from the LEDs 220. In the example embodiment of FIG. 8, the regulator switch and the output switch are operated at approximately 3.3 Volts (V). In other example embodiments, they may be operated at other voltages such as 5V or less than 6V.

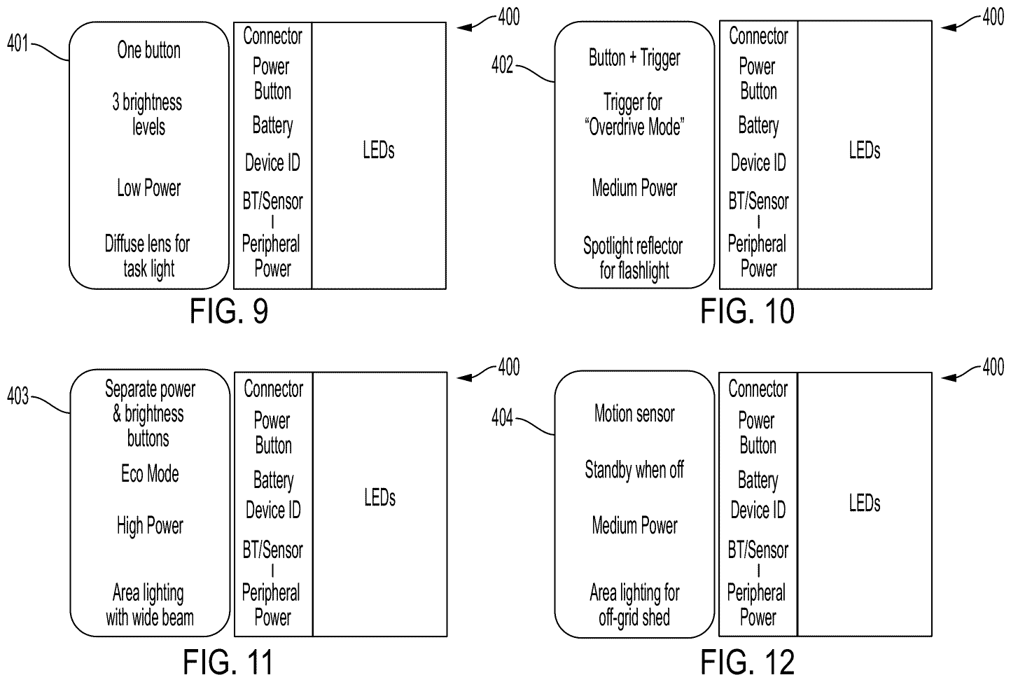

FIGS. 9, 10, 11 and 12 are explanatory drawings illustrating that the same lighting core 400 may be used for a variety of lighting products 401, 402, 403, 404. For example, lighting module 200 and battery 250 may create a core 400. This core 400 may be used for a task light 401. The task light 401 may have a user interface comprising one button. The task light 401 may have a plurality of brightness levels, such as three brightness levels. Task light 401 may be a low power usage device and/or have a low power usage mode. The task light 401 may have a diffuse lens for dispersing light.

The same or substantially similar core 400 may be used for a flashlight 402. The flashlight 402 may include a button and a trigger. The flashlight 402 may operate at a medium power level. The flashlight 402 may include a spotlight reflector.

The same or substantially the same core 400 may be included in a wide beam area lighting product 403. The area lighting product 403 may include separate power and brightness control buttons. The area lighting product 403 may include an eco mode in which power is conserved by operating at less than full power. The area lighting product 403 may be a high power application.

The same or substantially the same core 400 may be used in an off-grid area lighting product 404 for an off-grid application such as for use in a shed. The off-grid area lighting product 404 may include a motion sensor. The off-grid area lighting product 404 may be a medium power consumption product.

FIGS. 13 and 14 illustrate cross-sectional views of a flashlight 500 according to an example embodiment. The flashlight includes a handle 501 and a main body 502 which houses a battery pack 250. The flashlight 500 includes a door 503 that can open to allow the battery pack 250 to be inserted or removed. The battery pack 250 is received by batter pack receptacle 80. The front end of the flashlight 500 includes a light module 200 with LEDs 220. As in a previously described embodiment, a heat sink 320 with heat dissipating projections 321 is on a rear surface of the PCB 210 of the light module 200. Similar to the embodiment of FIGS. 4-7, the flashlight includes a housing with a reflector 341 and a housing. However, the light module housing 510 of the flashlight 500 is modified in comparison to the light module housing 430 to include a round front shape and to fit onto a front end of the flashlight main body 502. The light module housing 510 may include gaskets in a similar manner as light module housing 430.

FIGS. 15 and 16 illustrate an exemplary embodiment of a task light 530. The task light includes module 200 and heat sink 320 and a light module housing 520 modified for the size and shape of the task light 530 and in order to fit on the task light product. In the folding task light 530, the light module housing includes a pivoting head 525. The pivoting head 525 pivots around a pivot axis 526. The pivoting head 525 may also be pivotable about a second axis A that is generally perpendicular to the pivot axis 526. A base portion 527 may be configured to engage a power tool battery pack 250. An intermediate section 528 may connect the base portion 527 and the pivoting head 525. An actuator for turning on and off the task light 530 may be disposed on the base portion 527, the intermediate section 528 or the pivoting head 525.

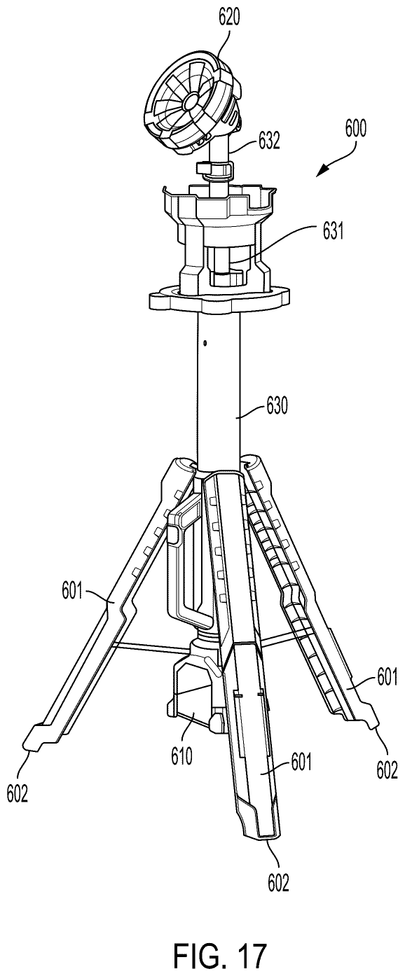

FIG. 17 illustrates another example embodiment of a light product 600 with which the light module 200, light module assembly 300 or components thereof may be used. As shown, the light product 600 is a tripod light. The tripod light has three legs 601. Each of the three legs 601 have a bottom surface 602. The bottom surfaces 602 may be placed on a surface, such as a stable flat horizontal surface, so that the tripod light 600 stands on the surface. A battery receptacle 610 is configured to receive a power tool battery pack 250 in order to power the light 600. The tripod light 600 includes a light head 620. The light head 620 may be pivotable to various positions. The light module 200 or light module assembly 300 may be included in the light head 620 to provide LEDs as a light source. The light head 620 may also be extendable up and down with respect to the legs 601 along supports 630, 631, and 632. The supports 630, 631, 632 may be telescoping supports. The light head 620 may be attached to an end of the support 632. The support 632 may be retractable into support 631. The support 631 may be retractable into support 630. The legs 601 may be slide along and be retractable to be around and or cover the support 630.

As explained above, the same or a substantially similar lighting module 200 may be used with a variety of different lighting products.

In an example embodiment, there may be a system including a first lighting product and a second lighting product. The first lighting product may include a first housing of a first configuration and the second lighting product may include a second housing of a second configuration. The first lighting product may be configured to be selectively powered by a power tool battery pack. The second lighting product may also be configured to be selectively powered by the power tool battery pack or a power tool battery pack with the same engagement configuration. Accordingly, the first and second lighting products may be powered by the same battery pack or system of power tool battery packs. For example, a first 20V power tool battery pack may be able to be engaged with the first lighting product to power the first lighting product. The first 20V power tool battery pack may then be able to be removed from the first lighting product and engaged with the second lighting product to power the second lighting product. The first 20V power tool battery pack may also be then engaged to a variety of power tools in a power tool system. For example, the first 20V power tool battery pack may be selectively engaged with a drill, an impact driver, a circular saw, a reciprocating saw, an oscillating multi-tool, a jigsaw and the like. A variety of 20V batteries may be compatible with the system and selectively engaged with the tools and the first lighting product and the second lighting product.

In an example embodiment, the first lighting product may include a first lighting module and the second lighting product may include a second lighting module. The first lighting module and the second lighting module may each have at least some components and configurations the same as that shown and described with respect to the module 200. The first lighting module and the second lighting module may each be configured in the manner described with respect to the module 200. The first lighting module and the second lighting module may have circuit boards which are the same size. The first lighting module and the second lighting module may each have the same number of LEDs. The first lighting module and the second lighting module may each have LEDs in the same array (e.g., each have a 3×3 array of LEDs). The first lighting module and the second lighting module may each have at least one connector 255 in the same location as shown in FIG. 3. The first lighting module and the second lighting module may each have groups of capacitors 251 as shown in the module 200 in FIG. 3. In example embodiments, the first lighting module may have any of the components as arranged and shown in the module 200 of FIG. 3 and the second lighting module may have any of the components as shown and arranged in the module 200 of FIG. 3, though each or one of the two may have less than all of the particular components shown in the module 200. For example, the first lighting module may include all of the components as shown in the module 200 and the second lighting module may be the same except that it may include a 4×4 array of LEDs.

The first lighting product may be any of a variety of lighting products such as the basket area light 100 of FIGS. 1 and 2, the flashlight of FIGS. 13 and 14, or the task light of FIGS. 15 and 16. The first lighting product may also be another type of light, such as a tripod light including a tripod support, a tower light, or a neck light. A tripod light may be a light including a tripod base. The second lighting product may be different than the first lighting product among the variety of lighting products. For example, the first lighting product may be the basket area light of FIGS. 1 and 2 and the second lighting product may be the flashlight of FIGS. 13 and 14. One light product may include a pivoting head with the light module on the pivoting head and a second light product may not have a pivoting head. A third lighting product may have a third lighting module may have any of the components as shown and arranged in the module 200 of FIG. 3 and may be a third type of lighting product in the system. Similarly, there may be a fourth lighting product, a fifth lighting product and so on. There may be at least two lighting products in the system, at least three lighting products in the system, or at least four lighting products in the system. In other example embodiments of the power tool system, there may be a first lighting product and a second lighting product with different power sources. For example, the first lighting product may be compatible with a 20V power tool battery pack 250 as described above. The second lighting product may have a different power source and may not be compatible with the 20V power tool battery pack 250 and instead be compatible with a power tool battery pack of another system such as an approximately 40V or 60V power tool battery pack system (maximum initial battery voltage measured without a workload.) The second lighting product power source may be an integral power source such as a 4V or 8V integral power source. Various other examples of lighting products that may be included in the system are shown in U.S. Patent Application Publication No. 2020/0263855; U.S. Patent Application Publication No. 2021/0364141; U.S. Patent Application Publication No. 2013/0265766; U.S. Patent Application Publication No. 2019/003657; U.S. Patent Application Publication No. 2008/0198588; or U.S. Patent Application Publication No. 2022/0128226. U.S. Patent Application Publication No. 2020/0263855; U.S. Patent Application Publication No. 2021/0364141; U.S. Patent Application Publication No. 2013/0265766; U.S. Patent Application Publication No. 2019/003657; U.S. Patent Application Publication No. 2008/0198588; and U.S. Patent Application Publication No. 2022/0128226 are each incorporated herein by reference.

In this manner, in example embodiments, a common or similar lighting module, such as the lighting module 200 or a lighting module including up to and including any and all components of the lighting module 200, may be used across a variety of products.

The foregoing description of the embodiments has been provided for purposes of illustration and description. It is not intended to be exhaustive or to limit the disclosure. Individual elements or features of a particular embodiment are generally not limited to that particular embodiment, but, where applicable, and can be combined, added to or exchanged with features or elements in other embodiments. The same may also be varied in many ways. Such variations are not to be regarded as a departure from the disclosure, and all such modifications are intended to be included within the scope of the disclosure.

Additionally, while exemplary embodiments are described with respect to an oscillating tool, the methods and configurations may also apply to or encompass other power tools such as other tools that hold power tools accessories.

What is claimed is:

1. A power tool light product, comprising:
a light body comprising a power tool battery pack receptacle, the power tool battery pack receptacle configured to removably receive a power tool battery pack that is configured to selectively power the power tool light product and at least one of a drill, a saw, a sander, or a concrete tool;
a lighting module, the lighting module operably coupled to the power tool battery pack receptacle;
wherein the lighting module comprises:
a printed circuit board;
an LED on the printed circuit board; and
an LED driver on the printed circuit board.

2. The power tool light product of claim 1, further comprising a controller on the printed circuit board.

3. The power tool light product of claim 1, wherein the LED driver is a constant current LED driver.

4. The power tool light product of claim 1, further comprising an integrated circuit regulator configured to provide a constant output voltage.

5. The power tool light product of claim 1, wherein the printed circuit board comprises an insulated metal substrate.

6. The power tool light product of claim 1, further comprising a connector.

7. The power tool light product of claim 6, wherein the connector is disposed near an edge of the printed circuit board.

8. The power tool light product of claim 6, wherein the connector is configured to facilitate connection of the controller to the power tool battery pack receptacle.

9. A power tool light product, comprising:
a light body comprising a power tool battery pack receptacle, the power tool battery pack receptacle configured to removably receive a power tool battery pack that is configured to selectively power the power tool light product and at least one of a drill, a saw, or a sander;
a lighting module assembly, the lighting module assembly comprising a lighting module, a heat sink and a lighting module housing;
wherein the lighting module comprises a printed circuit board having a front surface and a rear surface;
further comprising an LED on the front surface of the printed circuit board; and an LED driver on the front surface of the printed circuit board; and
wherein the heat sink extends from the rear surface of the printed circuit board.

10. The power tool light product of claim 9, wherein the lighting module housing comprises a reflector.

11. The power tool light product of claim 10, wherein comprising a gasket between the printed circuit board and the reflector.

12. The power tool light product of claim 11, wherein the printed circuit board comprises a central region and an outer region;
wherein the LED is in the central region.

13. The power tool light product of claim 12, wherein the gasket is around the central region of the printed circuit board.

14. The power tool light product of claim 9, further comprising a first gasket and a second gasket;
wherein the printed circuit board comprises a central region and an outer region;
wherein the LED is in the central region;
wherein the controller is in the outer region;
wherein the first gasket is around the central region;
wherein the second gasket is around the outer region.

15. The power tool light product of claim 9, wherein the heat sink comprises a plurality of heat dissipating projections extending in a direction transverse to the rear surface of the printed circuit board.

16. A power tool light system, comprising:
a first light product, the first light product comprising a first light body and a first power tool battery pack receptacle configured to removably receive a power tool battery pack;
wherein the first light product comprises a first lighting module, the first lighting module comprising a first printed circuit board, a first LED on the first printed circuit board, a first controller on the first printed circuit board, and a first LED driver on the first printed circuit board;
a second light product, the second light product comprising a second light body and a second power tool battery pack receptacle configured to removably receive a power tool battery pack;
wherein the second light product comprises a second lighting module, the second lighting module comprising a second printed circuit board, a second LED on the printed circuit board, a second controller on the printed circuit board, and a second LED driver on the second printed circuit board;
wherein the first light body has a different configuration than the second light body.

17. The power tool light system of claim 16, wherein the first light product comprises an area light; and
wherein the second light product comprises a flashlight.

18. The power tool light system of claim 16, the first LED driver is substantially the same as the second LED driver.

19. The power tool light system of claim 16, the first controller hardware is substantially the same as the second controller hardware.

20. The power tool light system of claim 16, the first printed circuit board has a first printed circuit board central region and a first printed circuit board outer region;
wherein the first LED is in the first printed circuit board central region;
wherein the first controller and the first LED driver are in the first printed circuit board outer region;
wherein the second printed circuit board has a second printed circuit board central region and a second printed circuit board outer region;
wherein the second LED is in the second printed circuit board central region; and
wherein the second controller and the second LED driver are in the second printed circuit board outer region.
